(19) United States
(12) Patent Application Publication
(10) Pub. No.: US 2021/0308550 A1
(43) Pub. Date: Oct. 7, 2021

(54) LIGHTING APPARATUS FOR BAG TOSS GAME

(71) Applicant: Jie Li, Shenzhen (CN)

(72) Inventor: Jie Li, Shenzhen (CN)

(21) Appl. No.: 17/351,276

(22) Filed: Jun. 18, 2021

(51) Int. Cl. A63B 71/06; A63B 67/06; F21V 23/04; F21V 33/00

(52) U.S. Cl. CPC A63B 71/0622; A63B 67/06; F21V 23/0471; F21V 23/0435; A63B 2220/801; A63B 2225/74; A63B 2225/50; A63B 2220/805; F21V 33/008

(57) ABSTRACT

A lighting apparatus for a bag toss game including a board having a hole is provided with a first light on a bottom of the hole; a controller on an underside of the board; a second light on edges of the board; and a remote controller for controlling both the first and second lights. The first light includes a laser sensor. The controller includes an internal PCB, a control chip on the PCB, and a vibration sensor on the PCB. Lighting is generated in response to bag hitting the board or entering the hole.

### BACKGROUND OF THE INVENTION

### 1. Field of the Invention

The invention relates to bag toss games and more particularly to a lighting apparatus for a bag toss game having improved characteristics.

### 2. Description of Related Art

Bag toss game is a kind of throwing games. In a bag toss game a player pitches a small bag filled with sand or plastic pellets. As technology evolves and increased popularity, boards having a lighting apparatus for decoration and illumination purposes are commercially available. Further, such boards can be customized or are DIY.

There is a conventional bag toss game equipped with LEDs (light-emitting diodes) provided in holes of a board. LEDs are powered by at least one cell. The LEDs can emit light of a predetermined color. However, the conventional bag toss game is monotonous and players are less interested in it. Thus, the need for improvement still exists.

### SUMMARY OF THE INVENTION

The invention has been made in an effort to solve the problems of the conventional art by providing a lighting apparatus for a bag toss game having novel and nonobvious characteristics.

To achieve above and other objects of the invention, the invention provides a lighting apparatus for a bag toss game including a board having a hole, comprising a first light provided on a bottom of the hole; a controller provided on an underside of the board; a second light provided on edges of the board; and a remote controller; wherein the first light includes at least one laser sensor and at least one LED; the controller includes an internal printed circuit board (PCB), a control chip provided on the PCB, and a vibration sensor provided on the PCB; and the remote control is configured to control both the first light and the second light for generating lighting therefrom.

Preferably, the controller further comprises a plurality of cells for supplying power to the laser sensor, the PCB, the vibration sensor, and the control chip; and wherein both the first and second lights are electrically connected to the control chip.

Preferably, the laser sensor is configured to sense a bag entering the first light and the vibration sensor is configured to sense vibration of the bag hitting the board.

Preferably, in response to sensing the bag entering the first light, the laser sensor sends bag hitting data to the control chip; and wherein the control chip is configured to activate both the first and seconds light to generate lighting as programmed.

Preferably, the controller further comprises a switch for controlling on and off of the lighting apparatus, and a pushbutton for activating lighting of both the first and second lights; and wherein both the switch and the pushbutton are electrically connected to the control chip.

Preferably, the controller further comprises a transceiver on the PCB for transmitting radio waves to the remote control and receiving radio waves therefrom, the transceiver being electrically connected to both the control chip and the cells; and an antenna on the PCB for communicating with the transceiver.

Preferably, the remote control includes an “ON” key for activating the controller, an “OFF” key for deactivating the controller, and a “SELECT” key for switching between the first light and the second light.

Preferably, the remote control includes a plurality of keys for setting colors of both the first and second lights.

Preferably, the controller and the first light are separate components prior to assembling on the board or the controller and the first light are formed integrally on the board.

Preferably, the remote control includes a “TEAM A” key and a “TEAM B” key both for a duel mode.

The lighting apparatus for a bag toss game of the invention has the following advantageous effects in comparison with the prior art: In playing, the laser sensor can sense a bag entering the hole and the vibration sensor can sense a bag hitting the board. Next, the control chip processes the bag hitting data sent from the laser sensor and processes the vibration data sent from the vibration sensor so as to generate lighting by means of the first light and the second light. Alternatively, the remote control can be operated to cause the first light and the second light to generate lighting as a replacement of the control chip. A user may program the lighting and the lighting apparatus is highly interactive. This is a contrast to the monotonous conventional bag toss game. Further, players are more interested in playing the bag toss game. The invention is economical and has wide applications.

The above and other objects, features and advantages of the invention will become apparent from the following detailed description taken with the accompanying drawings.

### BRIEF DESCRIPTION OF THE DRAWINGS

FIG. 1 is a perspective view of a lighting apparatus for a bag toss game according to the invention;

FIG. 2 is another perspective view of the lighting apparatus showing details on the bottom;

FIG. 3 is an exploded view of the lighting apparatus;

FIG. 4 is an exploded view of the lighting apparatus with the legs and the frame elements on the edges removed;

FIG. 5 is a view similar to FIG. 1 in condition of use;

FIG. 6 is a top view of the PCB;

FIG. 7 is a block diagram of the lighting apparatus;

FIG. 8 is a flow chart illustrating operations of the lighting apparatus;

FIG. 9 is a circuit diagram of the LED driver;

FIG. 10 is a circuit diagram of the wireless signals receiver and the demodulator;

FIG. 11 schematically depicts the remote control;

FIG. 12 is a perspective view of the controller;

FIG. 13 is a perspective view of the lighting apparatus showing the controller and the first light formed integrally on the board; and

FIG. 14 schematically depicts states of the lighting apparatus in operation.

### DETAILED DESCRIPTION OF THE INVENTION

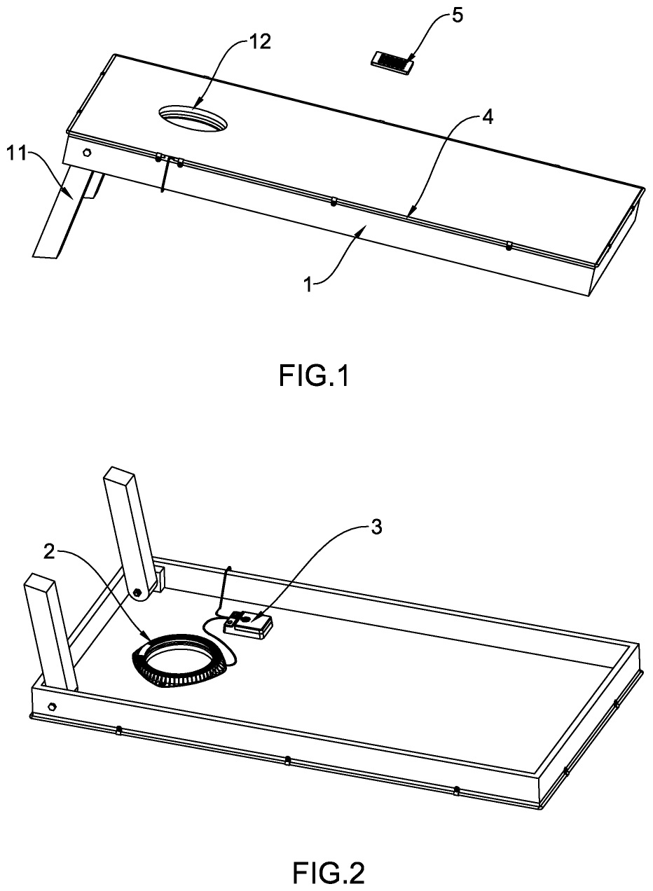

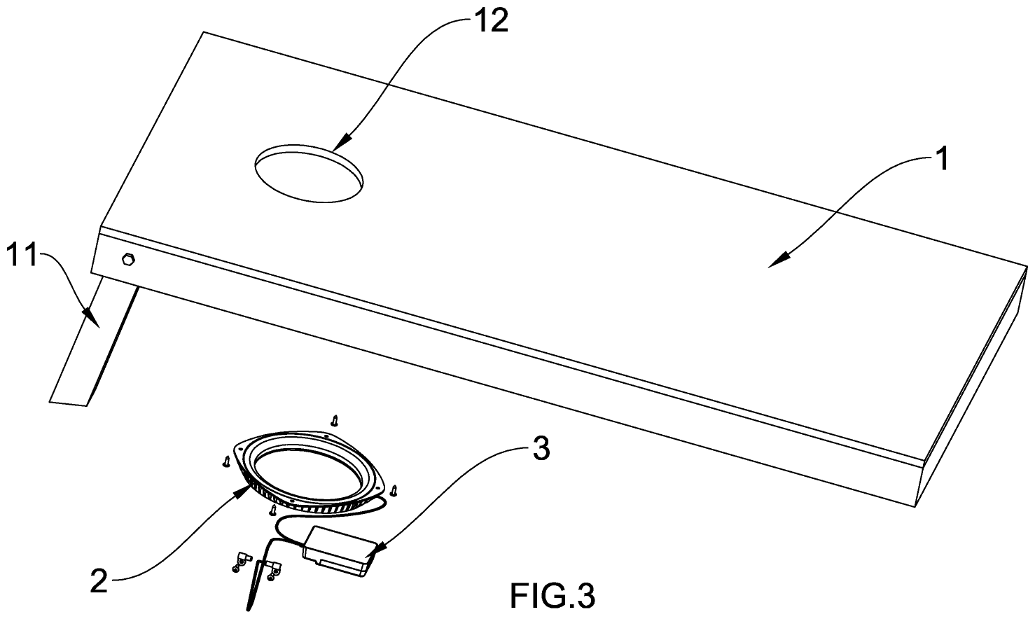

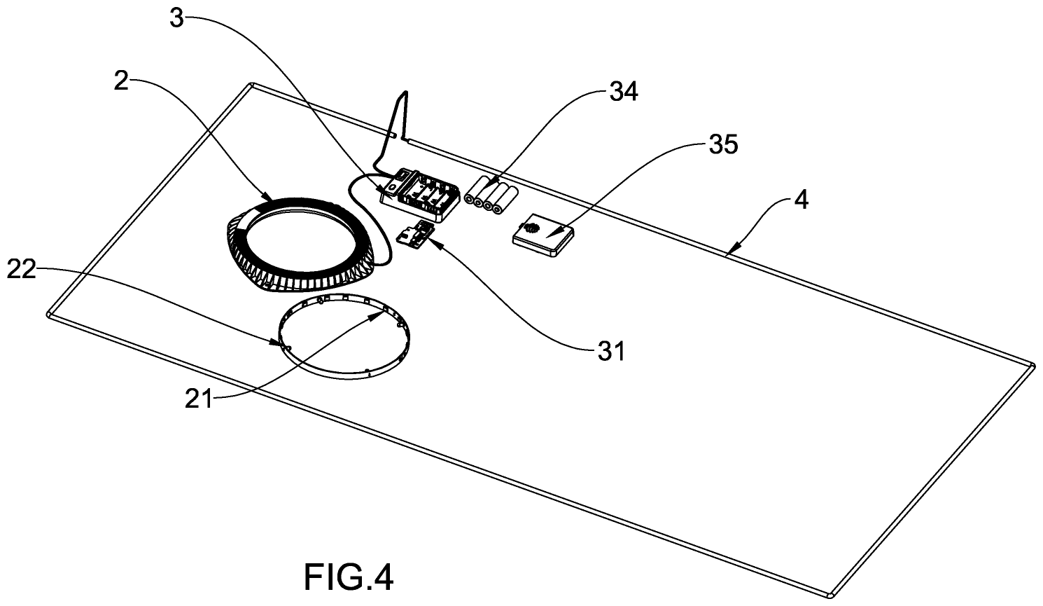

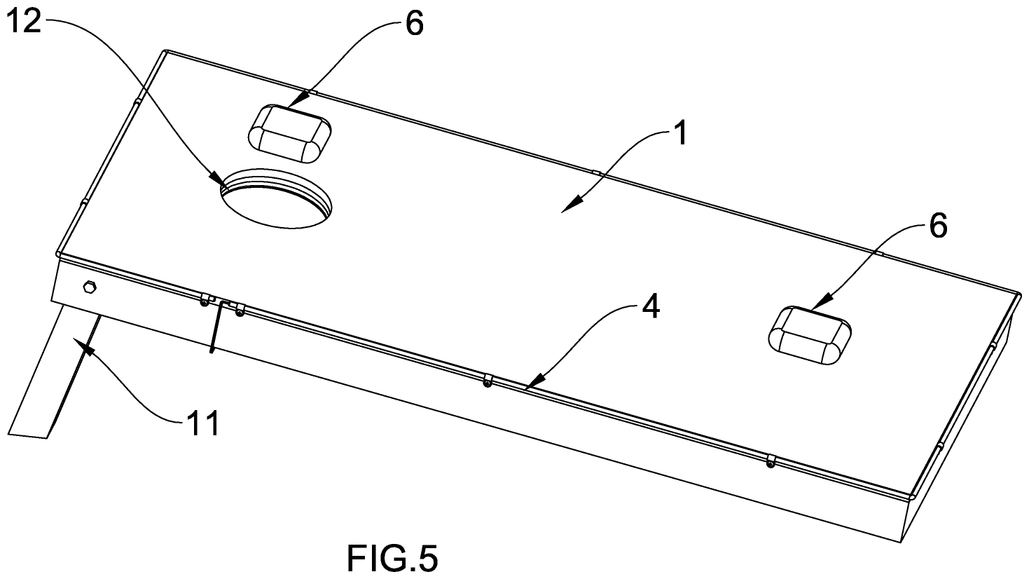

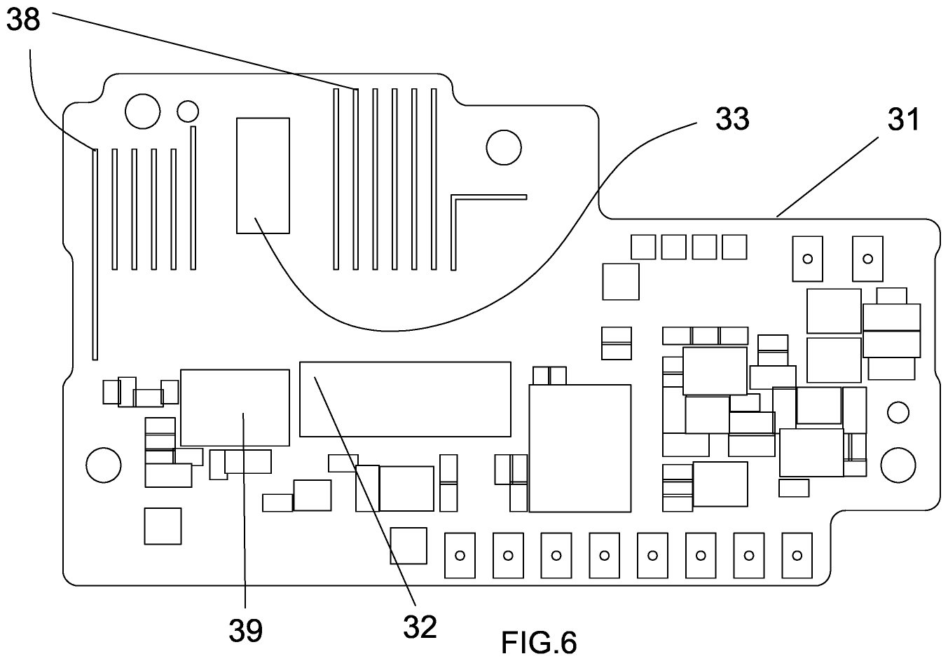

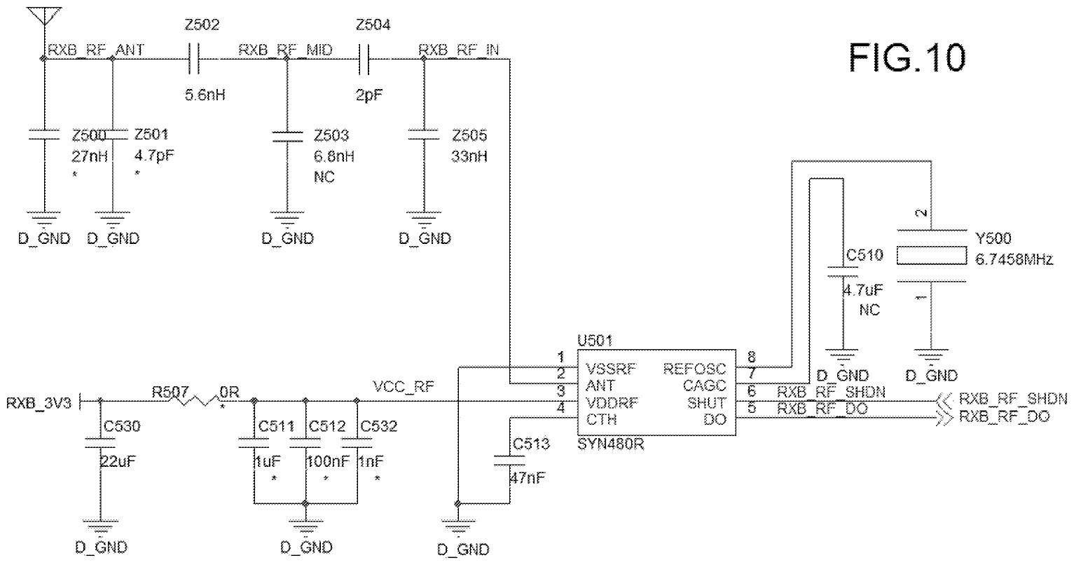

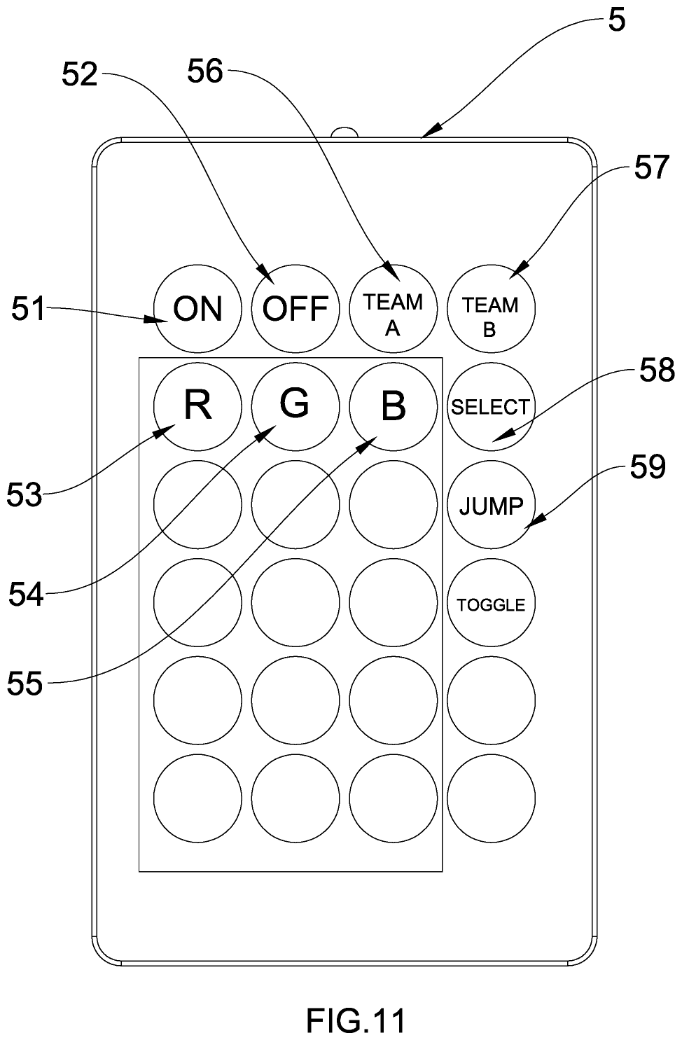

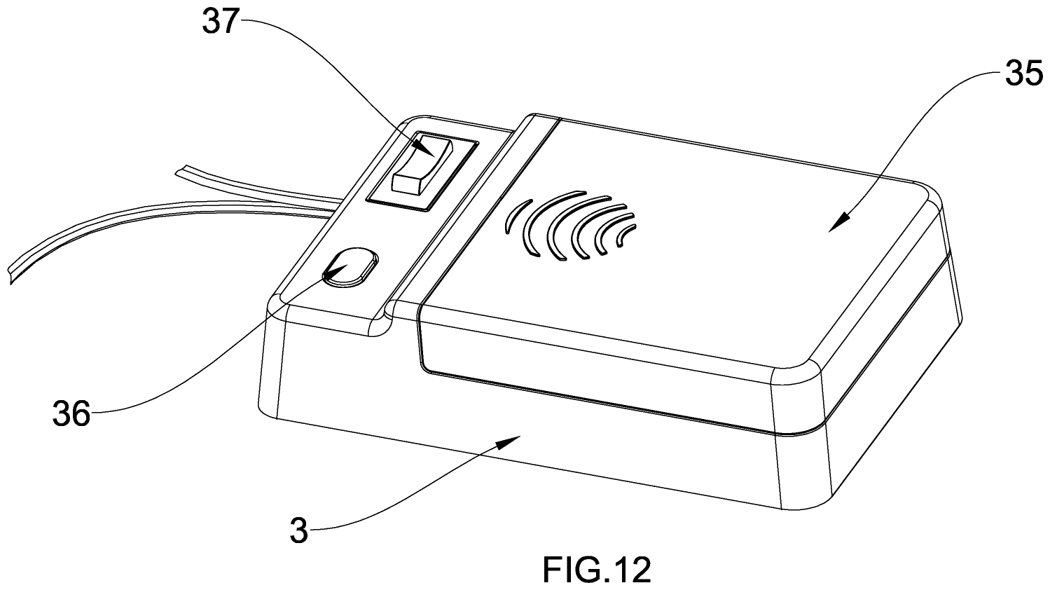

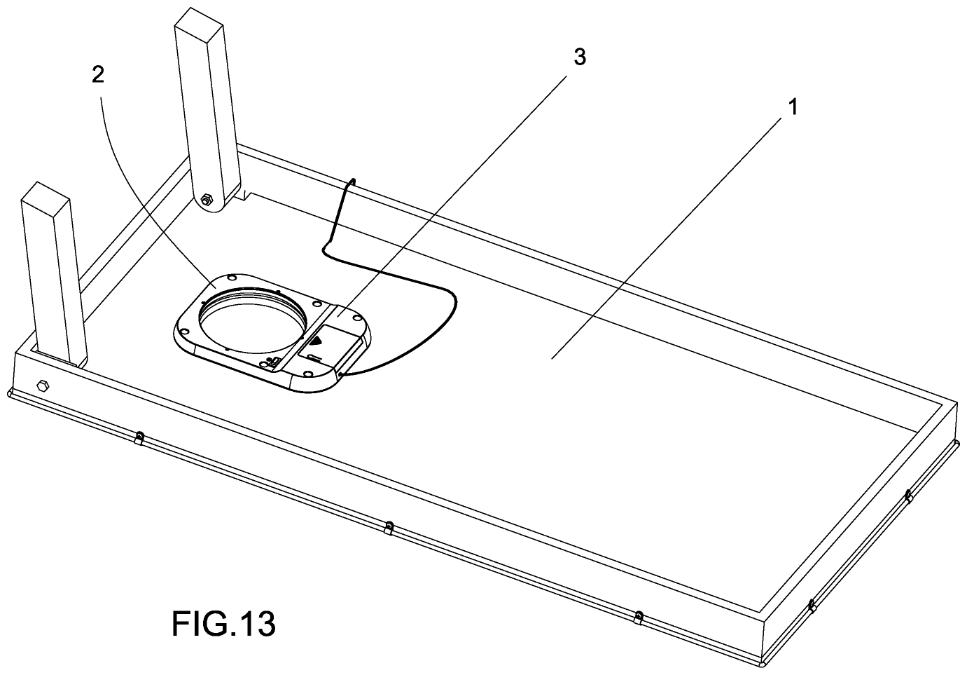

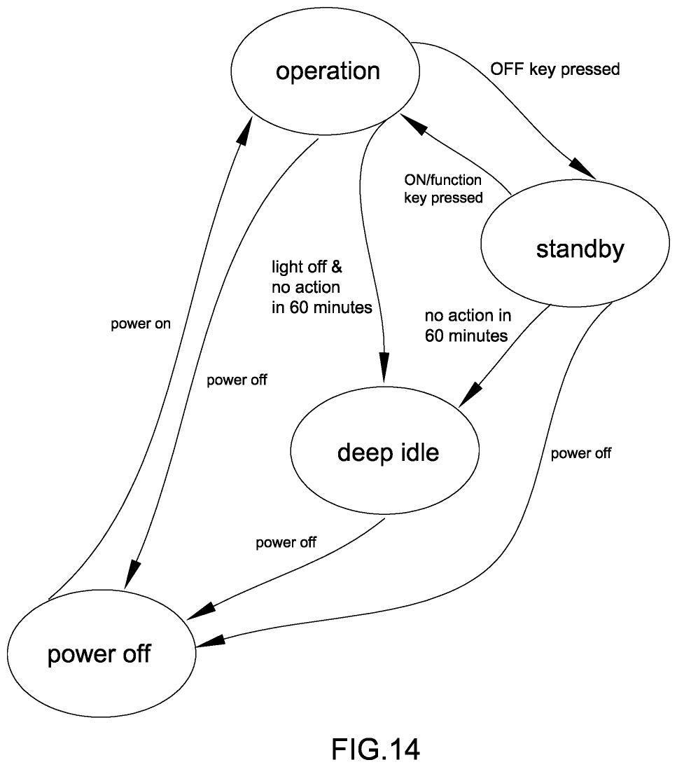

Referring to FIGS. 1 to 14, a lighting apparatus for a bag toss game in accordance with the invention is shown. The bag toss game includes a rectangular board 1 including two inclined legs 11 extending downward from two corners of one side, and a circular hole 12 through the board 1. The lighting apparatus includes a first light 2 provided on a bottom of the hole 12, a controller 3 provided on an underside of the board 1, a second light 4 provided on edges of the board 1, and a remote controller 5 as discussed in detail below.

The controller 3 and the first light 2 are separate components prior to assembling on the board 1. Alternatively, the controller 3 and the first light 2 are formed integrally on the board 1 as shown in FIG. 13. The first light 2 includes at least one laser sensor 21 and at least one LED 22. The controller 3 includes a housing (not numbered) and a printed circuit board (PCB) 31 in the housing, a control chip 32 provided on the PCB 31, and a vibration sensor 33 provided on the PCB 31. The remote control 5 is used to control both the first light 2 and the second light 4 for generating lighting from a distance. The laser sensor 21 can sense a bag 6 entering the first light 2 and the vibration sensor 33 can sense the hitting of the bag 6 on the board 1. The illumination of the both the first light 2 and the second light 4 can be controlled by the remote control 5 or the control chip 32. Also, both the first light 2 and the second light 4 are electrically connected to the control chip 32 via an LED driver (not shown). A preset light effect is brought about when the thrown bag 6 is sensed. In comparison with the conventional bag toss game, the invention allows a user to program lighting. Thus, the invention is highly interactive. And in turn, a player is more interested in playing the bag toss game of the invention. The invention is economical and has wide applications.

The controller 3 further comprises a plurality of internal cells 34 for supplying power to the laser sensor 21, the PCB 31, the vibration sensor 33, the LED driver and the control chip 32. On the housing of the controller 3, there are further provided a switch 37 for controlling on and off of the cells 34, and a pushbutton 36 for activating lighting of both the first light 2 and the second light 4. Both the switch 37 and the pushbutton 36 are electrically connected to the control chip 32. A transceiver 39 is provided on the PCB 31 for transmitting radio waves to the remote control 5 and receiving radio waves from the remote control 5. The transceiver 39 is electrically connected to the control chip 32. An antenna 38 is provided on the PCB 31 for communicating with the transceiver 39. The transceiver 39 is electrically connected to the cells 34.

In the invention, the control chip 32 is a microcontroller unit (MCU) for system control purpose. The control chip 32 receives data from the laser sensor 21 and/or the vibration sensor for determining whether the bag 6 hits the board 1 or passes through board 1. If yes, the LED driver activates both the first light 2 and the second light 4 to emit light. Finally, feedback information is sent to a user. The feedback information includes different colors of light and flashing emitted by both the first light 2 and the second light 4. The feedback information can be set using the remote control 5. In detail, the antenna 38 on the PCB 31 receives radio waves transmitted from the remote control 5. Further, the transceiver 39 demodulates the radio waves into baseband signals which are sent to the control chip 32 for processing. A user may press the pushbutton 36 to set feedback information in the absence of the remote control 5. In detail, the user may press the pushbutton 36 to switch between the first light 2 and the second light 4 in the absence of the remote control 5.

Prior to activation: Press the pushbutton 36 and turn on the switch 37 so that the remote control 5 cannot activate the board 1. This is a manual mode. After activation: Cyclically switch among “first light 2”, “second light 4” and “first light 2 and second light 4” every one second with the selected one being flashed. Once one of the “first light 2”, “second light 4” and “first light 2 and second light 4” (e.g., “second light 4”) is selected by pressing the pushbutton 36 for a relatively long time, the pushbutton 36 is released. Color of light emitted by the second light 4 is then selected by pressing the pushbutton 36 for a relatively short time.

Turning on the switch 37 activates the lighting apparatus and to the contrary, turning off the switch 37 deactivates the lighting apparatus. The lighting apparatus can be restarted whenever a system down is encountered.

The controller 3 further comprises a removable cover 35 so that a replacement of the cells 34 is made easy. When the bag 6 is sufficiently close to the first light 2 on its trajectory, the laser sensor 21 senses the bag 6 and generate a signal which is sent to the control chip 32. Both the first light 2 and the second light 4 are controlled by the control chip 32 to emit predetermined light.

The remote control 5 includes an “ON” key 51 and an “OFF” key 52 for activating the controller 3 or not. The remote control 5 further comprises a “SELECT” key 58 for switching between the first light 2 and the second light 4, and a plurality of keys for setting colors of both the first light 2 and the second light 4 in which the keys include an “R” key 53 corresponding to color read, a “G” key 54 corresponding to color green, and a “B” key 55 corresponding to color blue. The remote control 5 further comprises a “TEAM A” key 56, a “TEAM B” key 57, and a “TOGGLE” key.

The lighting apparatus has a duel mode and a single mode as detailed below.

Duel mode: A use turns on the switch 37 to select the duel mode. Next, the user presses both the “TEAM A” key 56 and the “TEAM B” key 57. Next, the user presses the “TEAM A” key 56 for lighting adjustment, presses the “SELECT” key 58 to select the first light 2 or the second light 4, and presses one of the “R” key 53, “G” key 54 and “B” key 55 to select color. For setting a news ticker mode, the user selects the “JUMP” key 59. The “TEAM B” key 57 can be pressed similarly.

Single mode: The user may wait or press a key other than the “TEAM A” key 56 and the “TEAM B” key 57 to enter the single mode.

Explanation of keys:

Pressing “ON” key 51 activates the lighting apparatus. Thereafter, both the first light and the second light 4 emit white light for one second. For the board 1 being programmed, groups are flashing. For example, group A flashes yellow light and group B flashes violet light.

Pressing “OFF” key 52 causes the lighting apparatus to enter a low energy consumption state. The lighting apparatus does not have the function of sensor but can be activated by using the remote control 5 or pressing the pushbutton 36. Thereafter, the lighting apparatus is activated. There are a number of methods to cause the lighting apparatus to leave the low energy consumption state to a wake-up state as detailed below. Press the “ON” key 51 of the remote control 5. Press the pushbutton 36. Pressing the “TEAM A” key 56 or the “TEAM B” key 57. Thus, the corresponding programming is enabled. Turning on the switch 37 restarts the lighting apparatus. The only difference among the methods is that programming of the remote control 5 is reset when the lighting apparatus has been restarted.

After the lighting apparatus has been restarted for less than 10 seconds, pressing the “TEAM A” key 56 to set the current board 1 as group A. In a normal operation, pressing the “TEAM A” key 56 selects the board 1 of the group A. The selected board 1 of the group A flashes yellow light. The selected board 1 of the group A flashes red light when operations are disabled. Pressing the “TEAM A” key 56 activates the board 1 of the group A when the lighting apparatus is deactivated. Group B is not activated.

After the lighting apparatus has been restarted for less than 10 seconds, pressing the “TEAM B” key 57 sets the current board 1 as group B. In a normal operation, pressing the “TEAM B” key 57 to select the board 1 of the group B. The selected board 1 of the group B flashes violet light. The selected board 1 of the group B flashes red light when operations are disabled. Pressing the “TEAM B” key 57 activates the board 1 of the group B when the lighting apparatus is deactivated. Group A is not activated.

Press the “SELECT” key 58 to cyclically switch among the first light 2, the second light 4 and the first light 2 and the second light 4 and select one of them with the selected one being flashed. Both the first light 2 and the second light 4 are selected automatically if there is no action from a user for more than 10 seconds. This is the default mode and it can decrease the number of operations.

Press the “JUMP” key 59 to enter the news ticker mode with three lights shown up to.

Press the “TOGGLE” key to turn on the selected light or turn off the selected light.

Press one of the “R” key 53, “G” key 54 and “B” key 55 of the remote control 5 to set color of light to be emitted by the first light 2 or the second light 4. It is noted that only the second light 4 emits light when the board 1 is shaken; and both the first light 2 and the second light 4 emit light when the bag 6 enters the circular hole 12.

Description of the first light 2 and the second light 4 is as below.

White light is emitted for one second means power on or the lighting apparatus is activated.

Yellow light is emitted means the board 1 of the group A is selected.

Violet light is emitted means the board 1 of the group B is selected.

Red light is emitted means the remote control 5 is disabled.

After the lighting apparatus has been activated for 10 seconds, pressing of the “TEAM A” key or the “TEAM B” key has no effect.

Pressing the “SELECT” key 58 to a light in which the color of flash is decided by the color of the selected light. The flashing is different from light emitted by any of above lights.

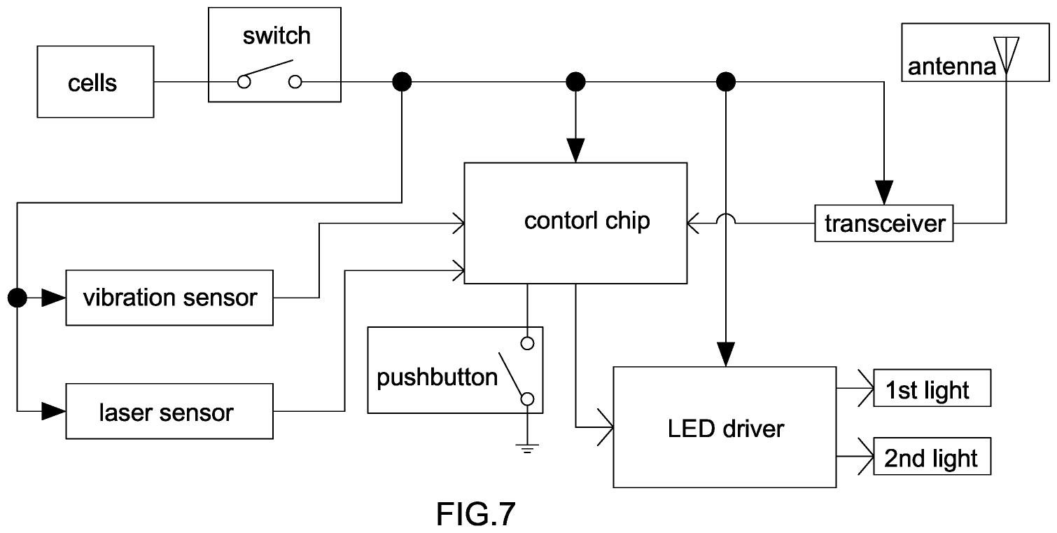

As illustrated in FIG. 7 specifically, it is a flow chart illustrating operations of the lighting apparatus. After the switch 37 has been turned on, the lighting apparatus is activated. Software program is run. GPIO of the control chip 32 is initialized, and then both the vibration sensor 33 and the laser sensor 21 are initialized. The lighting apparatus enter an endless task cycle. In the task cycle, the lighting apparatus monitors both the pressed key and the state of the transceiver 39. If there is user input, the lighting apparatus processes the input and activates the first light 2 and/or the second light 4 to change its color of light or brightness. If there is no user input, the software program receives signals from the vibration sensor 33 and/or the laser sensor 21 and runs an algorithm to determine whether the bag 6 has hit the board 1 or not. If there is bag hit, the LED driver activates the first light 2 and the second light 4 as programmed. Then the lighting apparatus enters a next cycle. The controller 3 is further provided with a loudspeaker and ports connected to the loudspeaker so that sound can be made when the first light 2 is activated. This increases interactivity of the lighting apparatus.

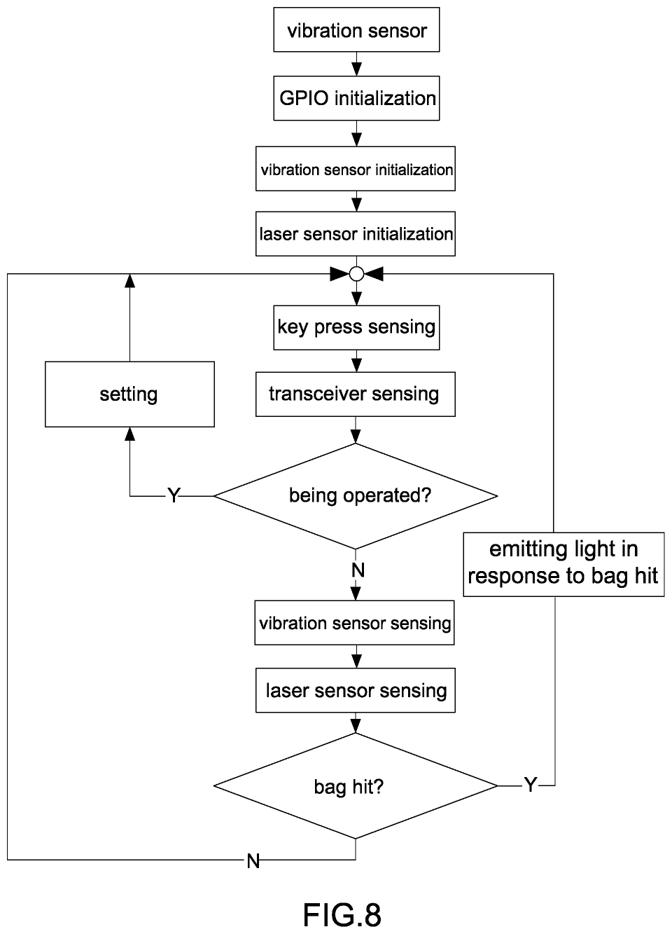

As shown in FIG. 8 specifically, it is a circuit diagram of the LED driver in which OUTER_VCC is power, OUT_A and OUT_B are control signals, TP502 and TP503 are LED board outputs, Q501 is PMOS logic, and Q502 is NMOS logic. When both the OUT_A and the OUT_B are low, output of the LED light is high. When both the OUT_A and the OUT_B are high, the output of the LED light is low. The state of the OUT_A being low and the OUT_B being high are not allowed. Two 20 Ohm resistors R514 and R515 are in parallel connection for increasing output power of the LED light. Two capacitors C520, C523 are in parallel connection at the output for decreasing EMC.

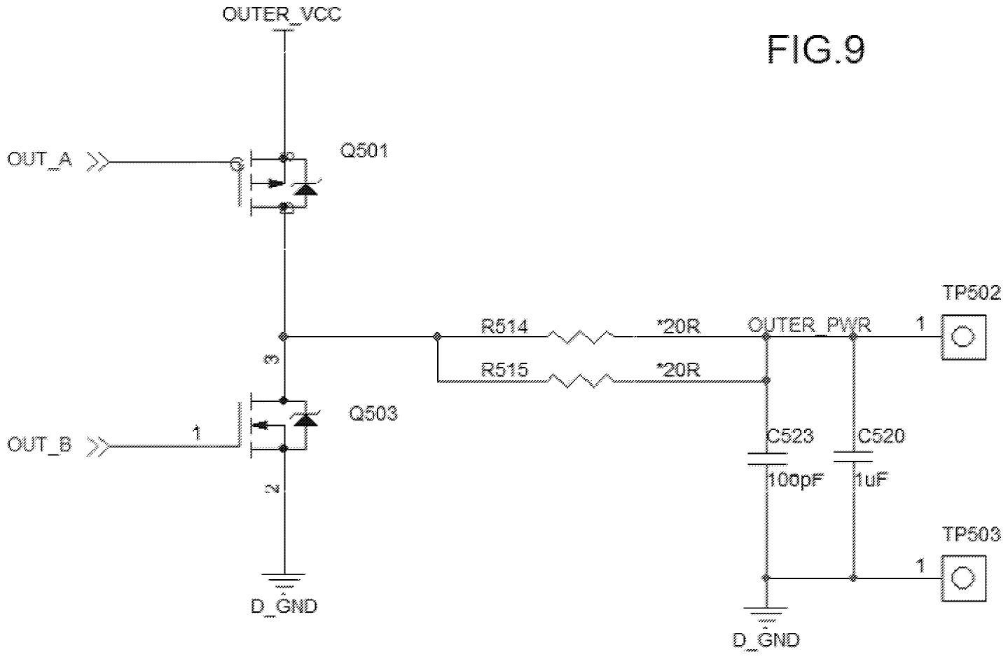

As shown in FIG. 9 specifically, it is a circuit diagram of the wireless signals receiver and the demodulator. Signals are sent from the antenna 38 to U501 for demodulation. Next, the demodulated signals are sent to the control chip 32 for processing via RXB_RF_DO. Finally, user information is obtained.

As illustrated in FIG. 13 specifically, it shows how the lighting apparatus saves energy of cells so that the lighting apparatus can have sufficient power for its normal operation.

In an operation mode, the lighting apparatus lights normally with full sensing capability. At this time, energy consumption is the maximum. Four series connected No. 5 cells can normally supply power for 48 hours. In the operation mode, when all lights are turned off with only sensing capability available, the lighting apparatus goes to an idle state for saving energy if there is no bag hitting being sensed or no radio waves being received from the remote control 5 for more than 60 minutes.

In a standby mode, a user may press the “OFF” key 52 of the remote control 5 to deactivate the lighting apparatus. Thereafter the user may press the “ON” key 51 of the remote control 5 or press the pushbutton 36 of the controller 3 to return to the operation mode in the immediately next 60 minutes. Energy consumption of the lighting apparatus in the standby mode is much lower than that in the operation mode. In the standby mode, about 0.2% of the capacity of the No. 5 cell is consumed in 60 minutes. The user may press the “ON” key 51 of the remote control 5 or press the pushbutton 36 of the controller 3 to return to the operation mode.

In a deep idle mode, the energy consumption is the minimum. 10% of the capacity of a No. 5 cell can maintain functions of the lighting apparatus for 2-3 years in the deep idle mode and such energy consumption is lower than a normal consumption of a nonuse cell. The lighting apparatus can return to the operation mode by restarting.

In a power off mode, the switch 37 is turned off and there is no electrical connection between the lighting apparatus and the cells. Energy of the cells is not consumed.

In playing, a user may throw a bag 6 onto the board 1. Thus, the board 1 vibrates. The vibration sensor 33 senses the vibration and collects vibration data. And in turn, the vibration sensor 33 sends the vibration data to the control chip 32. Thus, the control chip 32 activates both the first light 2 and the second light 4 to generate lighting as programmed.

In response to sensing the bag 6 entering the first light 2, the laser sensor 21 sends bag hitting data to the control chip 32. Thus, the control chip 32 activates both the first light 2 and the second light 4 to generate lighting as programmed.

In programming logic, the control chip 32 first processes the bag hitting data sent from the laser sensor 21 and then processes the vibration data sent from the vibration sensor 33. In short, the first light 2 lights first in response to bag 6 entering the hole 12 and the second light 4 lights second in response to the bag 6 hitting the board 1.

The invention has the following advantageous effects in comparison with the prior art: In playing, the laser sensor 21 can sense a bag 6 entering the hole 12 and the vibration sensor 33 can sense the bag 6 hitting the board 1. Next, the control chip 32 processes the bag hitting data sent from the laser sensor 21 and processes the vibration data sent from the vibration sensor 33 so as to generate lighting by means of the first light 2 and the second light 4. Alternatively, the remote control 5 can be operated to cause the first light 2 and the second light 4 to generate lighting as a replacement of the control chip 32. A user may program the lighting and the lighting apparatus is highly interactive. This is a contrast to the monotonous conventional bag toss game. Further, players are more interested in playing the bag toss game. The invention is economical and has wide applications.

While the invention has been described in terms of preferred embodiments, those skilled in the art will recognize that the invention can be practiced with modifications within the spirit and scope of the appended claims.

What is claimed is:

1. A lighting apparatus for a bag toss game including a board having a hole, comprising:
a first light provided on a bottom of the hole;
a controller provided on an underside of the board;
a second light provided on edges of the board; and
a remote controller;
wherein the first light includes at least one laser sensor and at least one LED;
the controller includes an internal printed circuit board (PCB), a control chip provided on the PCB, and a vibration sensor provided on the PCB; and
the remote control is configured to control both the first light and the second light for generating lighting therefrom.

2. The lighting apparatus of claim 1, wherein the controller further comprises a plurality of cells for supplying power to the laser sensor, the PCB, the vibration sensor, and the control chip; and wherein both the first and second lights are electrically connected to the control chip.

3. The lighting apparatus of claim 1, wherein the laser sensor is configured to sense a bag entering the first light and the vibration sensor is configured to sense vibration of the bag hitting the board.

4. The lighting apparatus of claim 1, wherein in response to sensing the bag entering the first light, the laser sensor sends bag hitting data to the control chip; and wherein the control chip is configured to activate both the first and seconds light to generate lighting as programmed.

5. The lighting apparatus of claim 1, wherein the controller further comprises a switch for controlling on and off of the lighting apparatus, and a pushbutton for activating lighting of both the first and second lights; and wherein both the switch and the pushbutton are electrically connected to the control chip.

6. The lighting apparatus of claim 1, wherein the controller further comprises a transceiver on the PCB for transmitting radio waves to the remote control and receiving radio waves therefrom, the transceiver being electrically connected to both the control chip and the cells; and an antenna on the PCB for communicating with the transceiver.

7. The lighting apparatus of claim 1, wherein the remote control includes an “ON” key for activating the controller, an “OFF” key for deactivating the controller, and a “SELECT” key for switching between the first light and the second light.

8. The lighting apparatus of claim 1, wherein the remote control includes a plurality of keys for setting colors of both the first and second lights.

9. The lighting apparatus of claim 1, wherein the controller and the first light are separate components prior to assembling on the board or the controller and the first light are formed integrally on the board.

10. The lighting apparatus of claim 1, wherein the remote control includes a “TEAM A” key and a “TEAM B” key both for a duel mode.
